(19) United States
(12) Patent Application Publication
(10) Pub. No.: US 2025/0350174 A1
(43) Pub. Date: Nov. 13, 2025

(54) EQUIPMENT FOR WELDING A MOTOR STATOR TO A SUBSTRATE

(71) Applicant: ASIA VITAL COMPONENTS CO., LTD., New Taipei City (TW)

(72) Inventors: Sung-Wei Sun, New Taipei City (TW); Ming-Che Lee, New Taipei City (TW)

(21) Appl. No.: 18/736,767

(22) Filed: Jun. 7, 2024

(30) Foreign Application Priority Data
May 13, 2024 (TW) 113117619

(51) Int. Cl. H02K 15/02; B23K 1/00; B23K 101/38; H02K 3/50

(52) U.S. Cl. CPC H02K 15/021; B23K 1/0008; H02K 3/50; B23K 2101/38; H02K 2215/00

(57) ABSTRACT

Equipment for welding a motor stator to a substrate includes a protective hood and a hot pressing head. The protective hood covers the motor stator and the substrate to protect the motor stator from undesired displacing and possible damage, and is provided with a plurality of wire slots, via which lead-out wires of coil windings of the motor stator can be pulled out to expose from the protective hood. The hot pressing head has a hot pressing end corresponding to welding points on the substrate and is movable to cover an outer side of the protective hood while the hot pressing end heats and welds the lead-out wires and the welding points together. With the equipment, all the coil windings of the motor stator can be welded to the substrate in one single movement while the motor stator is protected against splattered solders during the welding operation.

This application claims the priority benefit of Taiwan patent application number 113117619 filed on May 13, 2024, the disclosure of which is hereby incorporated by reference in its entirety.

### FIELD OF THE INVENTION

The present invention relates to stator welding equipment, and more particularly, to equipment for welding a motor stator to a substrate.

### BACKGROUND OF THE INVENTION

The cooling fan for use in a super slim notebook computer is subjected to limited axial space, which results in difficulty in aligning it with the welding points for electrical terminals U, V, W, and COM on a motor circuit board. Presently, to complete the electrical connection of the cooling fan to the circuit board, enameled wires are pulled manually to align them with the welding points. This procedure is difficult and highly challenged and the operator requires good eyes and rich experience to handle it. The above welding procedure in conventional motor stator connection requires a relatively long time because it could not be done on an automated mass-production line.

A prior motor stator assembly includes a stator core, at least one coil winding having at least one lead-out wire, a circuit board assembly, a plurality of metal posts, and a plurality of sleeves. The stator core includes a plurality of poles respectively having the coil winding wound therearound. The metal posts respectively include a first end surface and a second end surface, and the second end surface is fitly attached to the circuit board assembly. Each of the sleeves partially encloses one of the metal posts and is formed at a free end with a plurality of circumferentially spaced segments, such that a groove is defined between any two adjacent segments. The lead-out wire of the coil winding is extended through at least two grooves to straddle across the first end surface of the metal post.

In the above prior art motor stator assembly, when the lead-out wire of the coil winding has been manually pulled to extend through at least two corresponding grooves, the lead-out wire is further pulled outward to pass by one or two left or right segments before being further extended through two opposing grooves. Thereafter, the lead-out wire is pulled outward again to pass by one or two left or right segments and extend through another two opposing grooves before it is finally tied to the segment. Since the above lead-out wire is manually connected through complicate procedures and the operators are not all the same in their experience and skill, the lead-out wire might be unevenly or differently wound or tied to cause broken or loosened lead-out wire. Further, since the lead-out wire must be wound around and tied to the segments on the metal post multiple times, the whole lead-out wire connection consumes a lot of time and has low operational efficiency, and could not be processed through automated production.

Further, after the coil windings are completed, it is necessary to weld the coil windings to welding points. Presently, the welding is manually performed. The operator has to hold a soldering iron with one hand and the coil winding with another hand. The problem of broken windings tends to occur in the manual welding and it is hard to get consistent dimensions at the welded points, for example, to have inconsistent welding heights or interfere with other component or parts. The manual welding is also inefficient. Currently, there are not equipment and method available for achieving consistent and automated welding operation after the motor winding process.

It is therefore tried by the inventor to overcome the disadvantages in the prior art by developing improved equipment and method for welding a motor stator to a substrate.

### SUMMARY OF THE INVENTION

A primary object of the present invention is to provide equipment for welding a motor stator to a substrate, so that all the coil windings of the motor stator can be welded in one movement as soon as the coil windings are completed.

Another object of the present invention is to provide equipment for welding a motor stator to a substrate, so that solder splattering can be effectively prevented in the process of welding the motor stator coil windings.

To achieve the above and other objects, the equipment provided according to the present invention for welding a motor stator to a substrate includes a protective hood and a hot pressing head. The protective hood covers the motor stator and the substrate to protect the motor stator from undesired displacement and possible damage, and is provided with a plurality of wire slots, via which lead-out wires of coil windings of the motor stator can be pulled out to expose from the protective hood. The hot pressing head has a hot pressing end corresponding to welding points on the substrate and is movable to cover an outer side of the protective hood while the hot pressing end heats and welds the lead-out wires and the welding points together. With the equipment, all the coil windings of the motor stator can be welded to the substrate in one single movement while the motor stator is protected against splattered solders during the welding operation.

In an embodiment of the present invention, the motor stator includes a plurality of silicon steel laminations, which respectively have an upper and a lower insulated support. The silicon steel laminations are externally wound around by the coil windings, and the substrate is provided on one side having the motor stator mounted thereto with the welding points. And, the coil windings have outward extended lead-out wires.

In another embodiment, the wire slots on the protective hood are chamfered for guiding the lead-out wires of the coil windings of the motor stator to align with the welding points.

In a further embodiment, the hot pressing head is movable in a first, a second, and a third stroke. The hot pressing head in the first and the third stroke is located above the protective hood without covering the same; and the hot pressing head in the second stroke is located outside the protective hood to cover the protective hood therein while the hot pressing end is in contact with the welding points to heat and weld the lead-out wires and the welding points together. In other words, the welding operation does not start when the hot pressing head is in the first stroke, the welding operation is performed when the hot pressing head is in the second stroke, and the hot pressing head is moved to the third stroke when the welding operation is finished.

In an embodiment, the welding points have solders applied thereon. The applied solder has a thickness from 0.1 mm to 0.2 mm, and the substrate is a flexible printed circuit board (FPCB).

With the equipment according to the present invention for welding a motor stator to a substrate, the motor stator having coil windings wounded thereon can be fixed in place in the protective hood, and the protective hood protects the motor stator with wound coil windings against splattered solders during the welding operation. With the hot pressing end of the hot pressing head, all the lead-out wires of the motor stator can be welded to the welding points on the substrate in one single movement.

With the present invention, the operation of welding the motor stator to the substrate can be performed consistently using largely simplified manufacturing procedures.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a motor stator provided on a substrate;

FIG. 2 is an exploded perspective view showing a protective hood of equipment for welding a motor stator to a substrate according to the present invention before being covered on the motor stator and the substrate;

FIG. 3 shows a hot pressing head of the equipment of the present invention for welding the motor stator to the substrate is located in a first stroke;

FIG. 4A is a sectional side view showing the hot pressing head of the present invention is located in a second stroke;

FIG. 4B is a fragmentary, enlarged view of the circled area of FIG. 4A; and

FIG. 5 shows the hot pressing head of the present invention is located in a third stroke.

### DETAILED DESCRIPTION OF THE PREFERRED EMBODIMENTS

The present invention will now be described with a preferred embodiment thereof.

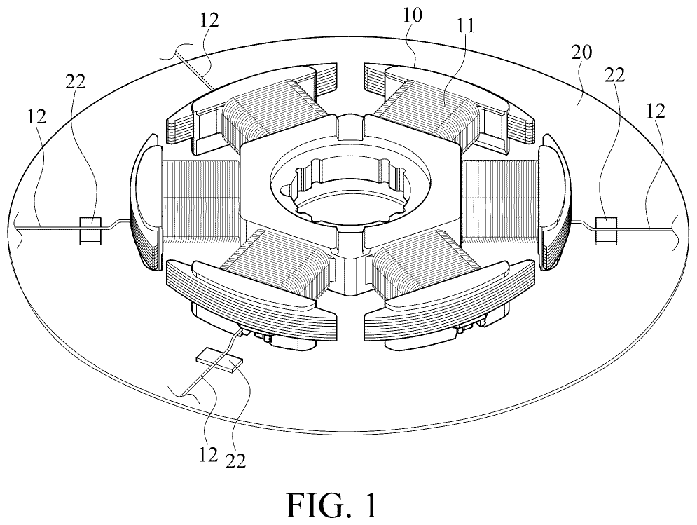

Please refer to FIG. 1, which shows a motor stator 10 provided on a substrate 20. As shown, the motor stator 10 has a plurality of coil windings 11 wound around a plurality of silicon steel laminations. In the case of a three-phase motor, there will be three wires U, V, W for the three phases and a neutral wire COM. Thus, there are total four lead-out wires 12. It is understood the motor is not limited to a three-phase motor. In other embodiments, the motor can be, for example, a single-phase motor. The silicon steel laminations on the motor stator 10 respectively have an upper and a lower insulated support located at an upper and a lower side thereof, and have the coil windings 11 wound around an outer side thereof. The motor stator 10 with the coil windings 11 is set on the substrate 20, and elastic elements, for example, can be provided on the substrate 20 for holding the coil windings 11 in place. One side of the substrate 20 having the motor stator 10 provided thereon is provided with a plurality of welding points 22, and the lead-out wires 12 of the coil windings 11 are located correspondingly on the welding points 22. As shown in FIG. 1, the welding points 22 are provided on the substrate 20 in advance, and the lead-out wires 12 of the coil windings 11 of the motor stator 10 are extended outward to contact with the preformed welding points 22 on the substrate 20 to facilitate subsequent welding operation.

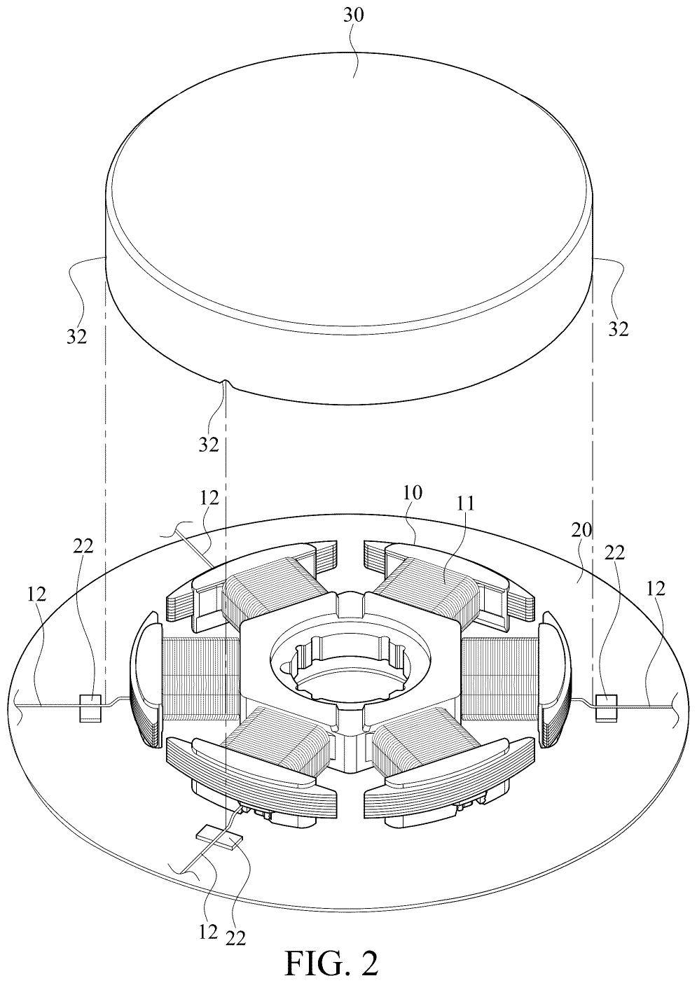

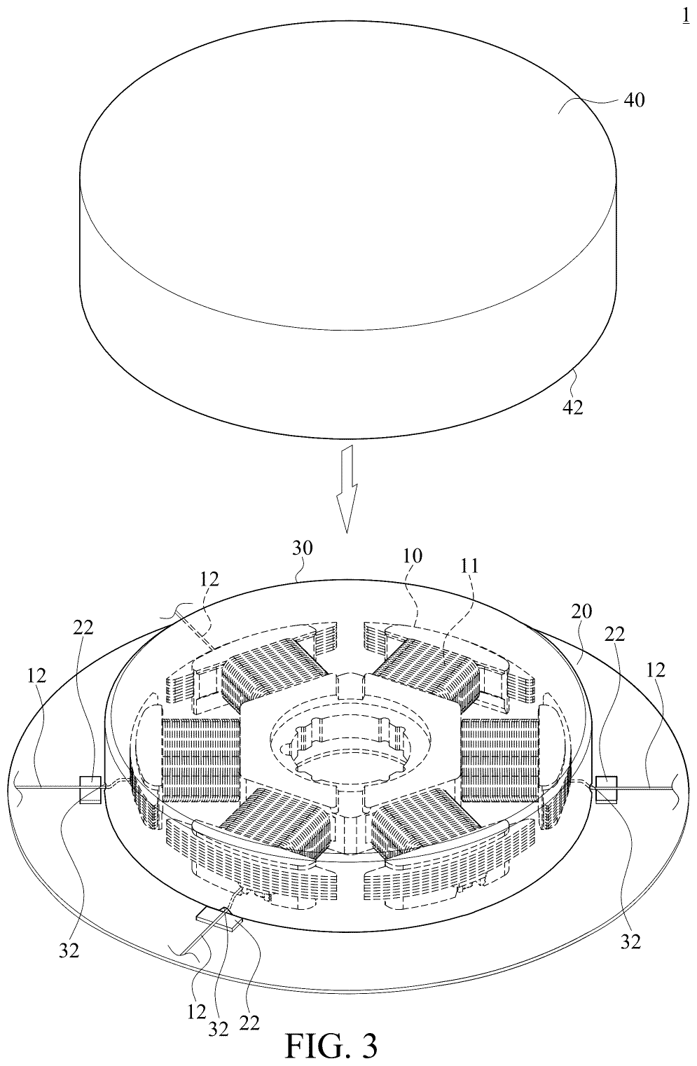

FIG. 2 is an exploded perspective view showing a protective hood 30 in a separated position above the motor stator 10 and the substrate 20; and FIG. 3 shows the protective hood 30 covers a top of the motor stator 10 and a hot pressing head 40 is in its first stroke above the motor stator 10. Please refer to FIG. 2 along with FIG. 3. Equipment 1 according to the present invention for welding the motor stator 10 to a substrate 20 includes a substrate 20, a protective hood 30, and a hot pressing head 40. The motor stator 10 is provided on the substrate 20, which includes, but not limited to, a circuit board or a flexible printed circuit board (FPCB). The substrate 20 has a plurality welding points 22 preformed thereon. Solder applied on the welding points 22 has a thickness, for example, from 0.1 mm to 0.2 mm without being particularly limited thereto. The protective hood 30 is correspondingly covered on a top of the substrate 20. The protective hood 30 can be, but not limited to, a hollow cylindrical hood, a cover or a cap. When the protective hood 30 is covered on the substrate 20, the motor stator 10 on the substrate 20 is shielded with the protective hood 30 and limited from displacing, so that the protective hood 30 provides both limiting and protecting effects to the motor stator 10. The protective hood 30 is provided along a rim of its opening with a plurality of wire slots 32, which are located corresponding to the welding points 22, such that the lead-out wires 12 of the coil windings 11 of the motor stator 10 can be extended through the wire slots 32 to expose from the protective hood 30. The wire slots 32 is chamfered for guiding the lead-out wires 12 of the coil windings 11 of the motor stator 10 to align with the welding points 22.

FIG. 3 shows the hot pressing head 40 of the coil winding welding equipment 1 is located in a first stroke thereof. As shown, the hot pressing head 40 has a hot pressing end 42 corresponding to the locations on the motor stator 10 and the substrate 20 that are to be welded. The hot pressing head 40 can be, for example, a hollow cylindrical hood or cover or cap, and is diametrically slightly larger than the protective hood 30 to cover the protective hood 30 therein. According to an embodiment, the hot pressing head 40 is movable in three strokes, namely, a first, a second, and a third stroke. When the hot pressing head 40 is in the first stroke, it has not yet covered the protective hood 30 therein and no welding is performed.

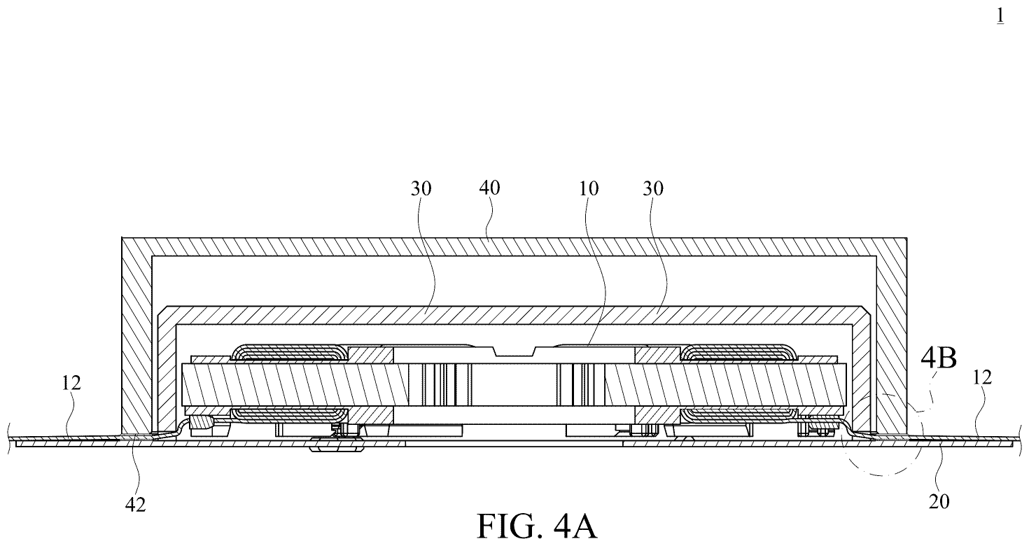

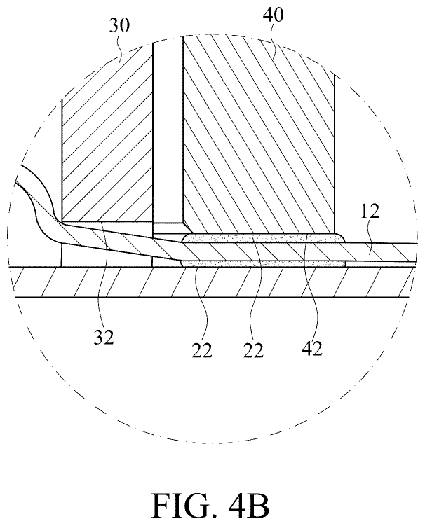

FIG. 4A is a sectional side view showing the hot pressing head 40 is in its second stroke. Please refer to FIG. 4A along with FIG. 3. In the second stroke, the hot pressing head 40 is moved to a location outside the protective hood 30 and the hot pressing end 42 is in contact with the welding points 22 to heat and weld all the lead-out wires 12 and the welding points 22 together in one single movement, making the motor stator welding operation consistent and efficient. In the process of welding, the motor stator 10 is covered in the protective hood 30 to avoid undesired displacement and any damage caused by splattering solder.

FIG. 4B is a fragmentary, enlarged view of the circled area of FIG. 4A. As shown, the hot pressing head 40 is in its second stroke to perform the welding operation. At his point, the hot pressing end 42 of the hot pressing head 40 is in contact with the welding points 22 and melts the solder thereon. When the protective hood 30 covers the motor stator 10 therein, the lead-out wires 12 are extended through the wire slots 32 to expose from the protective hood 30. With these arrangements, the motor stator 10 would not displace undesirably during the welding operation, and molten solder would not splatter over the motor stator 10. That is, with the protective hood 30, the motor stator 10 is held in place on the substrate 20 and well protected against splattered solders. At last, the lead-out wires 12 of the motor stator 10 are welded to the welding points 22 by the hot pressing head 40.

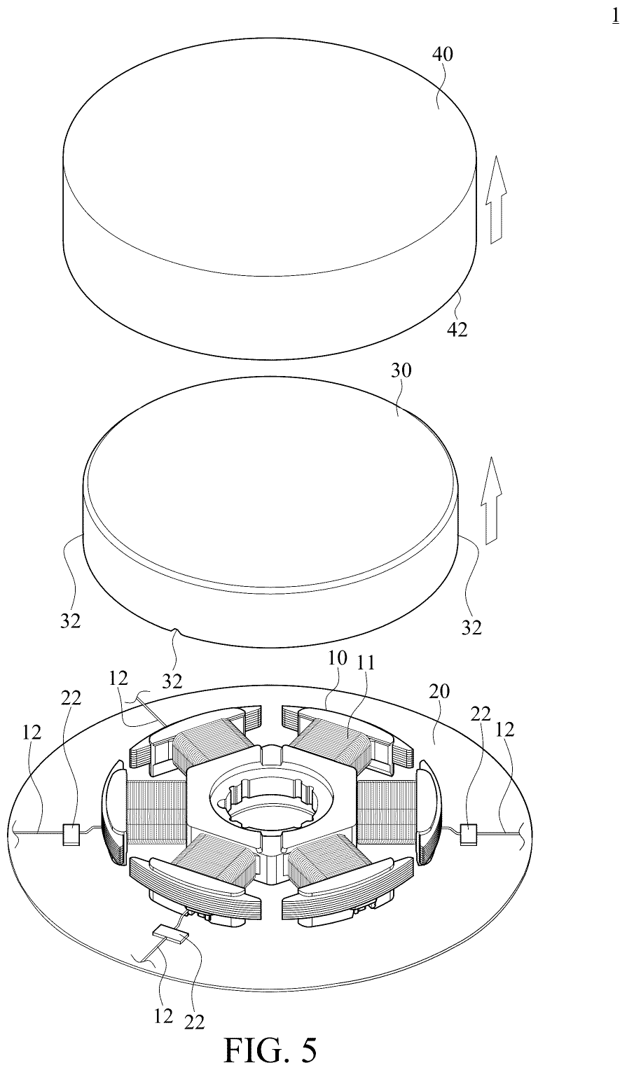

FIG. 5 shows the hot pressing head 40 is in its third stroke. As shown, when the welding operation is finished, the hot pressing head 40 is lifted to the third stroke and no longer covers the protective hood 30. Thereafter, the protective hood 30 can be removed from the substrate 20 to complete the welding of the motor stator 10.

The hot pressing head 40 of the present invention can be moved in three strokes, i.e. a first, a second, and a third stroke. When the hot pressing head 40 is in the first and the third stroke, it does not cover on the protective hood 30. When the hot pressing head 40 is in its second stroke, it is located outside the protective hood 30 to cover the same while the hot pressing end 42 is in contact with the welding points 22 to facility subsequent safe welding operation. In other words, the hot pressing head 40 is in the first stroke before the welding operation starts, in the second stroke during the welding operation, and in the third stroke when the welding operation is finished.

The welding equipment according to the present invention are applicable to the process of welding a motor stator to a substrate. With the present invention, all the lead-out wires of the coil windings on the motor stator can be welded to the welding points in one single movement, and the protective hood holds the motor stator in place during the welding operation and protects the motor stator against splattered solders.

The present invention has been described with a preferred embodiment thereof and it is understood that many changes and modifications in the described embodiment can be carried out without departing from the scope and the spirit of the invention that is intended to be limited only by the appended claims.

What is claimed is:

1. Equipment for welding a motor stator to a substrate, comprising:
a protective hood for covering the motor stator and the substrate to prevent the motor stator from displacing undesirably and protect the motor stator against possible damage; the protective hood being provided with a plurality of wire slots, via which lead-out wires on the motor stator can be pulled out to expose from the protective hood; and
a hot pressing head having a hot pressing end corresponding to locations on the substrate at where the motor stator is to be welded; the hot pressing head being movable to cover an outer side of the protective hood while the hot pressing end heats and welds the lead-out wires of the motor stator and the welding locations on the substrate together.

2. The equipment for welding a motor stator to a substrate as claimed in claim 1, wherein the motor stator includes a plurality of silicon steel laminations, which respectively have an upper and a lower insulated support and are externally wound around by a plurality of coil windings; the substrate being provided on one side having the motor stator provided thereon with a plurality of welding points, and the lead-out wires of the coil windings being pulled outward to align with the welding points; and the wire slots on the protective hood being chamfered for guiding the lead-out wires of the coil windings of the motor stator to align with the welding points more easily.

3. The equipment for welding a motor stator to a substrate as claimed in claim 2, wherein the hot pressing head is movable in a first, a second, and a third stroke; the hot pressing head in the first and the third stroke being located above the protective hood without covering the protective hood; and the hot pressing head in the second stroke being located around the outer side of the protective hood to cover the protective hood therein while the hot pressing end is in contact with the welding points to heat and weld the lead-out wires and the welding points together.

4. The equipment for welding a motor stator to a substrate as claimed in claim 3, wherein the welding operation does not start when the hot pressing head is in the first stroke, the welding operation is performed when the hot pressing head is in the second stroke, and the hot pressing head is moved upward to the third stroke when the welding operation is finished.

5. The equipment for welding a motor stator to a substrate as claimed in claim 2, wherein the welding points have solders applied thereon.
